(19) United States
(12) Patent Application Publication
(10) Pub. No.: US 2012/0011176 A1
(43) Pub. Date: Jan. 12, 2012

(54) LOCATION INDEPENDENT SCALABLE FILE AND BLOCK STORAGE

(75) Inventor: Alexander Aizman, Mountain View, CA (US)

(73) Assignee: Nexenta Systems, Inc., Mountain View, CA (US)

(21) Appl. No.: 12/874,978

(22) Filed: Sep. 2, 2010

Related U.S. Application Data
(60) Provisional application No. 61/362,260, filed on Jul. 7, 2010.
(60) Provisional application No. 61/365,153, filed on Jul. 16, 2010.

(51) Int. Cl. G06F 17/30

(52) U.S. Cl. 707/822; 707/E17.01; 707/E17.032

(57) ABSTRACT

A method and system is disclosed for resolving a single server bottleneck. Logically associated data is typically collocated within a single filesystem or a single block device accessible via a single storage server. A single storage server can provide a limited I/O bandwidth, which creates a problem known as “single I/O node” bottleneck. The method and system provides techniques for spreading I/O workload over multiple I/O domains, both local and remote, while at the same time increasing operational mobility and data redundancy. Both file and block level I/O access are addressed.

### CROSS-REFERENCE TO RELATED APPLICATION

This application is claiming under 35 USC 119(e), the benefit of provisional patent application Ser. No. 61/362,260, filed Jul. 7, 2010, and the benefit of provisional patent application Ser. No. 61/365,153, filed Jul. 16, 2010.

### FIELD OF THE INVENTION

The present invention generally relates to storage systems, and more specifically to the Network Attached Storage (NAS) systems also called filers, and Storage Area Network targets (storage targets).

### BACKGROUND OF THE INVENTION

With the ever increasing number of users and power of the applications simultaneously accessing the data, any given storage server potentially becomes a bottleneck, in terms of available I/O bandwidth. A given single storage server has a limited CPU, memory, network and disk I/O resources. Therefore, the solutions to the problem of a “single server” or “single I/O node” bottleneck involve, and will in the foreseeable future continue to involve, various techniques of spreading the I/O workload over multiple storage servers. The latter is done, in part, by utilizing existing clustered and distributed filesystems. The majority of the existing clustered and distributed filesystems are proprietary or vendor-specific. Clustered and distributed filesystems typically employ complex synchronization algorithms, are difficult to deploy and administer, and often require specialized proprietary software on the storage client side.

The very first and so far the only industry-wide standard is Parallel NFS (pNFS), which is part of the IETF RFC for NFS version 4.1. Quoting one of the early pNFS problem statements:

“Scalable bandwidth can be claimed by simply adding multiple independent servers to the network. Unfortunately, this leaves to file system users the task of spreading data across these independent servers. Because the data processed by a given data-intensive application is usually logically associated, users routinely co-locate this data in a single file system, directory or even a single file. The NFSv4 protocol currently requires that all the data in a single file system be accessible through a single exported network endpoint, constraining access to be through a single NFS server.”

Today, several years after this statement was first published, a single filesystem on a single storage server remains a potential bottleneck in presence of growing number of NFS clients.

Parallel NFS (pNFS) approach to the above stated problem is: separation of the filesystem metadata and data—and therefore, control and data paths. In pNFS, a single metadata server (MDS) contains and controls filesystem metadata, while multiple data servers (DS) provide for file read and write operations on the data path. While it is certainly true that the data path is often responsible for most of the aggregate I/O bandwidth, the metadata/data separation approach has its inherent drawbacks. The metadata/data separation approach includes complex processing to synchronize concurrent write operations performed by multiple clients, and inherent scalability problem in presence of intensive metadata updates. Additionally, the pNFS IETF standardization process addresses only the areas of pNFS client and MDS interoperability, but not the protocol between metadata servers and data servers (DS). Therefore, there are potential issues in terms of multi-vendor deployments.

Parallel NFS (pNFS) exemplifies design tradeoffs present in the existing clustered filesystems, which include the complexity of synchronizing metadata and data changes in presence of concurrent writes by multiple clients, and additional levels of protections required to prevent metadata corruption or unavailability (a “single point of failure” scenario). A system and method in accordance with the present invention addresses these two important issues, which are both related to the fact that metadata is handled separately and remotely from actual file data.

The single server bottleneck applies to the block storage as well. Block storage includes storage accessed via the Small Computer System Interface (SCSI) protocol family. SCSI itself is a complex set of standards that, among other standards includes SCSI Command Protocol and defines communications between hosts (or SCSI Initiators) and peripheral devices, also called SCSI Logical Units (LU). SCSI protocol family includes parallel SCSI, Fibre Channel Protocol (FCP) for Fibre Channel, Internet SCSI (iSCSI), Serial Attached SCSI (SAS), and Fibre Channel over Ethernet (FCoE). All of these protocols serve as transports of SCSI commands and responses between hosts and peripheral devices (e.g., disks) in a SCSI-compliant way.

On the block storage side, the conventional mechanisms of distributing I/O workload over multiple hardware resources include a variety of techniques: LUN mapping and masking, data striping and mirroring, I/O multipathing. LUN mapping and masking, for instance, can be used to isolate (initiator, target, LUN)—defined I/O flows from each other, and apply QoS policies and optimizations on a per flow bases. Still, a certain part of the I/O processing associated with a given LU is performed by a single storage target (that provides this LU to SCSI hosts on Storage Area Network). The risk of hitting a bottleneck is then proportional to the amount of processing performed by the target.

If the entire storage target or its part (e.g., transport protocol stack) is implemented in the software, the corresponding risk often becomes a reality. Examples include: software iSCSI implementations, LUN emulation on top of existing filesystems, and many others. There are multiple factors, including time to market and cost of maintenance, that drive vendors to move more and more of the I/O processing logic from the hardware and firmware into the software stacks of major operating systems. It is known, for instance, that it is difficult to deliver a hardware based iSCSI implementation. On the other hand, when implemented in the software, iSCSI may utilize most or all of the server resources, due to its intensive CRC32c calculation and re-copying of the received buffers within host memory. The same certainly holds for LUN emulation, whereby all layers of the storage stack including SCSI itself are implemented in the software. The software provides advanced sophisticated features (such as snapshotting a virtual device or deduplicating its storage), but comes at a price of all the corresponding processing being performed by a single computing node.

A single disk, physical or virtual, based on a single physical disk or array of disks, can then become a bottleneck. A single disk, whether it is physical or virtual, accessed via a single computing node with its limited resources may become the bottleneck, in terms of total provided I/O bandwidth.

There is therefore the need for solutions that can be used to remove the single server bottleneck both on the file (single filesystem) and block (single disk) levels. There is the need for solutions that can be deployed using existing proven technologies, with no or minimal changes on the storage client side. The present invention addresses such a need.

### SUMMARY OF THE INVENTION

Logically associated data is typically collocated within a single filesystem or a single block device accessible via a single storage server. A single storage server can provide a limited I/O bandwidth, which creates a problem known as “single I/O node” bottleneck.

The majority of existing clustered filesystems seek to scale the data path by providing various ways of separating filesystem metadata from the file data. The present invention does the opposite: it relies on existing filesystem metadata while distributing parts of the filesystems, each part being a filesystem itself as far as operating system and networking clients are concerned, each part is usable in isolation and available via standard file protocols.

In the first aspect of the present invention, a method for resolving a “single NAS” bottleneck is disclosed. This method comprises performing one or more of the following operations: a) splitting a filesystem into two or more filesystem “parts”; b) extending a filesystem residing on a given storage server with its new filesystem “part” in a certain specified I/O domain, possibly on a different storage server; c) migrating or replicating one or more of those parts into separate I/O domains; d) merging some or all of the filesystem parts to create a single combined filesystem. In addition, the filesystem clients are redirected to use the resulting filesystem spanning multiple I/O domains.

In the second aspect of the present invention, a method for resolving a single block-level storage target bottleneck is disclosed. This method comprises performing one or more of the following operations: a) splitting a virtual block device accessed via a given storage target into two or more parts; b) extending a block device with a new block device part residing in a certain specified I/O domain; c) migrating or replicating one or more of those parts into separate I/O domains; d) merging some or all of those parts to create a single combined virtual block device. In addition, hosts on the Storage Area Network (SAN) are redirected to access and utilize the resulting block devices in their respective I/O domains.

A method and system in accordance with the present invention introduces split, merge, and extend operations on a given filesystem and a block device (LU), to distribute I/O workload over multiple storage servers.

Embodiments of systems and methods in accordance with the present invention include filesystems and block level drivers that control access to block devices. A method and system in accordance with the present invention provides techniques for distributing I/O workload, both file and block level, over multiple I/O domains, while at the same time relying on existing mature mechanisms, proven standard networking protocols, and native operating system APIs.

A method and system in accordance with the present invention provides for applications (such as filesystems, databases and search engines) to utilize faster, more expensive, and possibly smaller in size disks for certain types of data (e.g. database index), while at the same time leveraging existing, well-known and proven replications schemes (such as RAID-1, RAID-5, RAID-6, RAID-10, etc.). In addition, embodiments provide for integrated backup and disaster recovery, by integrating different types of disks, some of which may be remotely attached, in a single (heterogeneous) data volume. To achieve these objectives, a system and method in accordance with the present invention is can rely fully relying on, existing art, as far as caching, physical distribution of data blocks in accordance with the chosen replication schemes, avoidance of a single point of failure, and other well-known and proven replications schemes.

### BRIEF DESCRIPTION OF THE DRAWINGS

FIG. 1 illustrates transitions from the early filesystems managing a single disk, to filesystem managing a single volume of data disks, to multiple filesystems sharing a given volume of data disks.

FIG. 2 illustrates filesystem spanning two different data volumes.

FIG. 3 illustrates a super-filesystem that spans two I/O domains.

FIG. 4 illustrates a filesystem split at directory level.

FIG. 5 illustrates I/O domain addressing on a per file basis.

FIG. 6 illustrates filesystem migration or replication via shared storage.

FIG. 7 illustrates partitioning of a filesystem by correlating I/O workload to its parts.

FIG. 8A and FIG. 8B are conceptual diagrams illustrating LBA mapping applied to SCSI command protocol.

### DETAILED DESCRIPTION OF THE INVENTION

The present invention generally relates to storage systems, and more specifically to the Network Attached Storage (NAS) systems also called filers, and Storage Area Network targets (storage targets). The following description is presented to enable one of ordinary skill in the art to make and use the invention and is provided in the context of a patent application and its requirements. Various modifications to the preferred embodiments and the generic principles and features described herein will be readily apparent to those skilled in the art. The phrase “in one embodiment” in this specification does not necessarily refers to the same embodiment. Thus, the present invention is not intended to be limited to the embodiments shown, but is to be accorded the widest scope consistent with the principles and features described herein.

Terms

| Abbreviation | Definition | Extended Definition |
|---|---|---|
| pNFS | Parallel NFS | http://www.ietf.org/rfc/rfc5661.txt |
| MS-DFS | Distributed File System (Microsoft) | http://en.wikipedia.org/wiki/Distributed_File_System_%28Microsoft%29 |
| SAN | Storage Area Network | http://en.wikipedia.org/wiki/Storage_area_network |
| SCSI | Small Computer System Interface | http://en.wikipedia.org/wiki/Scsi |
| Data volume | Data volume combines multiple | http://en.wikipedia.org/wiki/Logical_volume_management |
| | storage devices to provide for more | |
| | capacity, data redundancy, and I/O | |
| | bandwidth | |
| NAS | Network-attached storage (NAS) is | http://en.wikipedia.org/wiki/Network-attached_storage |
| | file-level computer data storage | |
| | connected to a computer network | |
| | providing data access to | |
| | heterogeneous clients. | |
| Clustered | A clustered filesystem is a filesystem | http://en.wikipedia.org/wiki/Clustered_file_system |
| filesystem | that is simultaneously mounted on | |
| | multiple storage servers. A clustered | |
| | NAS is a NAS that is providing a | |
| | distributed or clustered file system | |
| | running simultaneously on multiple | |
| | servers. | |
| Data striping | Techniques of segmenting logically | http://en.wikipedia.org/wiki/Data_striping |
| | sequential data and writing those | |
| | segments onto multiple physical or | |
| | logical devices (Logical Units) | |
| I/O multipathing | techniques to provide two or more | http://en.wikipedia.org/wiki/Multipath_I/O |
| | data paths between storage clients and | |
| | mass storage devices, to improve | |
| | fault-tolerance and increase I/O | |
| | bandwidth | |

### Introduction

In any given system with limited resources the issue of scalability can be addressed in the following two common ways:

(a) re-balancing available resources within the system between critical and less-critical client applications;
(b) relocating or replicating part of the data, and with it, part of the client generated workload to a different storage system, or systems.

A typical operating system includes a filesystem, or plurality of filesystems, providing mechanism for storing and retrieving, changing, creating and deleting files. Filesystem can be viewed as a special type of a database designated specifically to store user data (in files), as well as control information (called “metadata”) that describes layout and properties of those files.

In the context of a single filesystem within a single storage server providing file services to multiple local or remote clients, the corresponding re-balancing and relocating operations can be then more exactly described as follows:

(a′) relocating part (or all) of the filesystem to use a different set of resources within a given storage server.
(b′) relocating or replicating part (or all) of the filesystem to a different storage server. Conversely, there will be applications and scenarios benefiting from collocating multiple filesystems residing on different storage servers onto one single storage server, or a single storage volume within a storage server.

The present invention introduces split, merge, and extend operations on a given filesystem, to distribute file I/O workload over multiple storage servers. The existing stable and proven mechanisms, such as NFS referrals (RFC 5661) and MS-DFS redirects, are reused and relied upon.

A system that utilizes a location independent scalable file and block storage in accordance with the present invention can take the form of an implementation of entirely hardware, entirely software, or may be an implementation containing both hardware-based and software-based elements. In one implementation, this disclosure is implemented in software, which includes, but is not limited to, application software, firmware, resident software, program application code, microcode, etc.

Furthermore, the system and method of the present invention can take can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program or signals generated thereby for use by or in connection with the instruction execution system, apparatus, or device. Further a computer-readable medium includes the program instructions for performing the steps of the present invention. In one implementation, a computer-readable medium preferably carries a data processing or computer program product used in a processing apparatus which causes a computer to execute in accordance with the present invention. A software driver comprising instructions for execution of the present invention by one or more processing devices and stored on a computer-readable medium is also envisioned.

The medium can be an electronic, magnetic, optical, electromagnetic, infrared, or semiconductor system (or apparatus or device) or a propagation medium, or a signal tangibly embodied in a propagation medium at least temporarily stored in memory. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

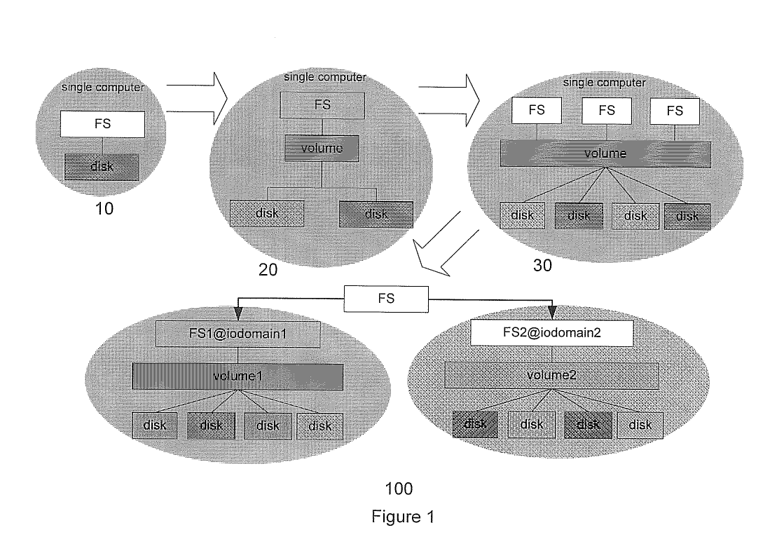

Historically, filesystem technology has progressed, in terms of the ability to utilize data disks. FIG. 1 illustrates the transitions from the early filesystems managing a single disk 10, to filesystem managing a single volume of data disks 20, to multiple filesystems sharing a given volume of data disks 30.

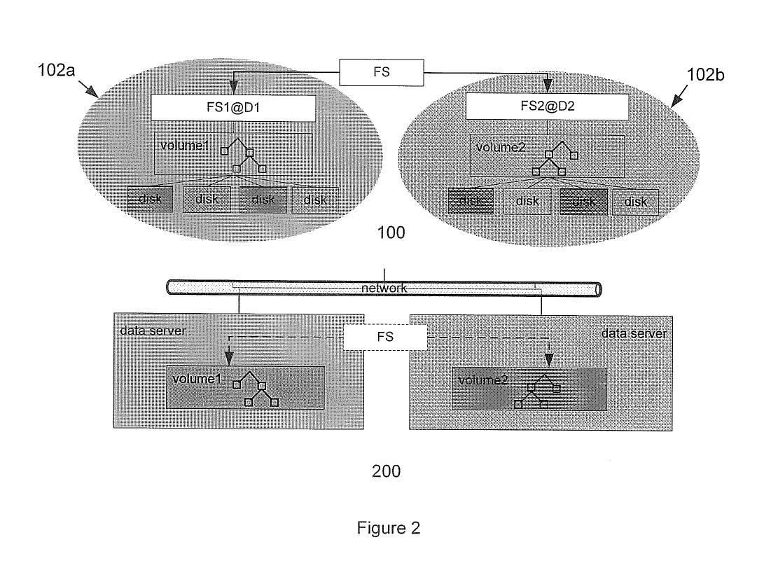

The single server bottleneck problem arises from the fact that, while filesystem remains a single focal point under pressure by an ever-increasing number of clients, the underlying disks used by the filesystem are still being accessed via a single storage server (NAS server or filer). A system and method in accordance with the present invention breaks this barrier, by introducing filesystem spanning multiple data volumes as illustrated in FIG. 2.

FIG. 2 illustrates a filesystem spanning two different data volumes; at its bottom portion it shows that these two data volumes may reside within two different storage servers.

Embodiments of a method and system in accordance with the present invention partition a filesystem in multiple ways that are further defined by specific administrative policies and goals of scalability. In the most general way this partitioning can be described as dividing a filesystem using a certain rule that unambiguously places each file, existing and future, into its corresponding filesystem part. In embodiments split, extend, and merge operations on a filesystem are introduced. Each filesystem part resulting from these operations is a filesystem in its own right, accessible via standard file protocols and native operating system APIs. In combination, these filesystem “parts” form a super-filesystem that in turn effectively contains them. The latter super-filesystem spanning multiple I/O domains appears to clients exactly as the original non-partitioned filesystem.

The “single server” bottleneck applies to the block storage as well. The latter includes storage accessed via the Small Computer System Interface (SCSI) protocol family: parallel SCSI, Fibre Channel Protocol (FCP) for Fibre Channel, Internet SCSI (iSCSI), Serial Attached SCSI (SAS), and Fibre Channel over Ethernet (FCoE). All these protocols serve as transports of SCSI commands and responses between hosts and peripheral devices (also called SCSI Logical Units) in a SCSI-compliant way.

Virtualization of hardware resources is a global trend, with storage servers installed with storage software effectively virtualizing the underlying hardware drives, JBOD and RAID arrays as Logical Units that can be created and destroyed, and thin provisioned (to be later expanded or reduced in size) on the fly and on demand, without changing the underlying hardware. As a software controlled entity, such Logical Unit can be then:

(a″) relocated or replicated, in part or entirely, to use a different set of resources within a given storage server.
(b″) relocated or replicated, in part or entirely, to a different storage server.

Embodiments in accordance with a method and system in accordance with the present invention partition a given Logical Unit (LU) in multiple ways that are further defined by the custom policies and the goals of spreading I/O workload. In the most general way this partitioning can be described as dividing a given range of addresses [0, N], where N indicates the last block of the original LU (undefined—for tapes, defined by its maximum value—for thin-provisioned virtual disks), into two or more non-overlapping sets of blocks that in combination produce the original entire range of blocks. This capability to partition an LU into blocks is in turn based on the fundamental fact that SCSI command protocol addresses block devices as linear sequences of blocks. A system and method in accordance with the present invention distributes block I/O workload over multiple I/O domains, by mapping SCSI Logical Block Addresses (LBA) based on a specified control information, and re-directing modified I/O requests to alternative block devices, possibly behind different storage targets. A system and method in accordance with the present invention provides techniques for distributing I/O workloads, both file and block level, over multiple I/O domains, while at the same time relying on existing mature mechanisms, proven standard networking protocols, and native operating system APIs.

### File Storage

A method and system in accordance with the present invention introduces split, extend, and merge operations on a filesystem. Each filesystem part resulting from these operations is a filesystem in its own right, accessible via standard file protocols and native operating system APIs. In combination, these filesystem parts form a super-filesystem that in turn effectively contains them. The latter super-filesystem spanning multiple I/O domains appears to clients exactly as the original non-partitioned filesystem.

Each filesystem part residing on its own data volume is a filesystem in its own right, available to local and remote clients via standard file protocols and native operating system APIs. In combination, these filesystem parts form a super-filesystem that in turn effectively contains them.

A method and system in accordance with the present invention provides for filesystems spanning multiple I/O domains. In the context of this invention, I/O domain is defined as a subset of physical and/or logical resources of a given physical computer. I/O domain is a logical entity that “owns” physical, or parts of the physical, resources of a given physical storage server including CPUs, CPU cores, disks, RAM, RAID controllers, HBAs, data buses, network interface cards. I/O domain may also have properties that control access to physical resources through the operating system primitives, such as threads, processes, the thread or process execution priority, and similar.

Data volume within a given storage server is an example of I/O domain—an important example, and one of the possible I/O domain implementations (FIG. 1).

I/O domains 102a and 102b shown in FIG. 2 may, or may not, be collocated within a single storage server. It is often important, and sufficient, to extend a given filesystem onto a different local data volume, or more generally, into a different local I/O domain.

A method and system in accordance with the present invention provides for distributing an existing non-clustered filesystem. Unlike the conventional clustered and distributed filesystems, a method and system in accordance with the present invention do not require the filesystem data to be initially distributed or formatted in a special “clustered” way. In one embodiment, existing filesystem software is upgraded with a capability to execute split, extend, and merge operations on the filesystem, and store additional control information that includes I/O domain addressing. The software upgrade is transparent for the existing local and remote clients, and backwards compatible, as far as existing filesystem-stored data is concerned.

Traditionally, filesystems' metadata—that is, persistent data that stores information about filesystem objects including files and directories—includes filesystem-specific data structure called “inode”. For instance, an inode that references a directory will have its type defined accordingly and will point to the data blocks that store a list of inodes (or rather, inode numbers, unique within a given filesystem) of the constituent files and nested directories. An inode that references a file will point to data blocks that store the file's content.

A method and system in accordance with the present invention introduces additional level of indirection, called I/O domain addressing, between the filesystem and its own objects. For those filesystems that use inodes in their metadata—which includes majority of Unix filesystems and NTFS—this translates as a new inode type that, instead of pointing to its local storage, redirects to a new location of the referenced object. Conventionally, an inode contains control information and pointers to data blocks. Those data blocks are stored on a data volume where the entire filesystem, with all its data and metadata, resides. Embodiments of method and system in accordance with the present invention provide for additional inode type that does not contain actual pointers to locally stored content. Instead, it would redirect via special type of pointer called “I/O domain address” to a remote sibling inode residing in a remote I/O domain. The new inode type is created on demand (for instance, as a result of split operation) and is not necessarily present, which also makes the embodiments backwards compatible as far as existing on-disk format of the filesystems.

The additional control information, in combination referred henceforth as “split metadata”, includes location specific I/O domain addressing that can be incorporated into an existing filesystem metadata at all levels in the filesystem management hierarchy. The hierarchy can include the level of the entire filesystem, devices (including virtual devices) the filesystem uses to store its files, directory, file, and the data block level.

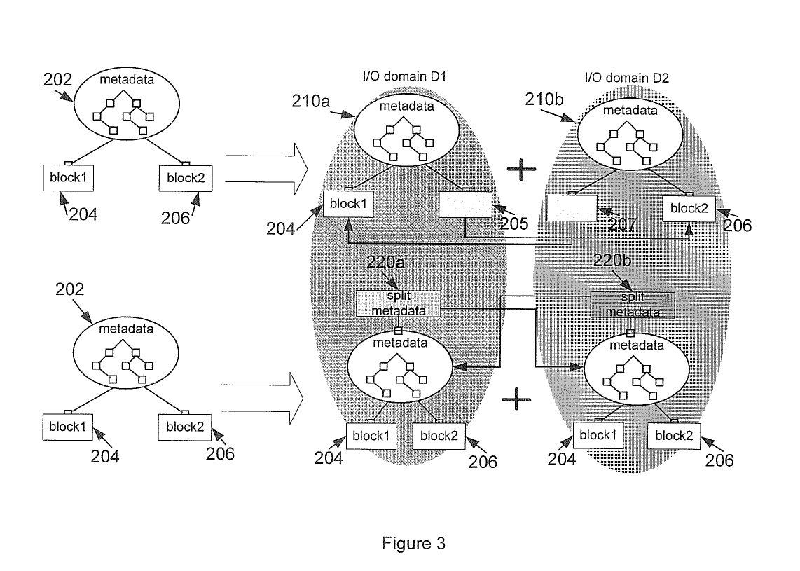

A system and method in accordance with the present invention does not preclude using I/O domain addressing on the block level, which would allow redirecting block read and write operations to a designated I/O domain, possibly on a different data volume, on a per range of blocks basis (top portion of FIG. 3). Block level redirection would remove the benefit of relative mutual independence of the filesystem parts; on the other hand it allows splitting or striping files across multiple I/O domains. This benefit may outweigh the “cons” in certain environments.

A system and method in accordance with the present invention does not preclude using I/O domain addressing on a per file basis either. Generally, any given inode within a filesystem may redirect to its content via I/O domain address directly incorporated into the inode structure. The latter certainly applies to inode of the type ‘file’. Preferred embodiments have their file storage managed by Hierarchical Storage Management (HSM) or similar tiered-storage solutions that have the intelligence to decide on the locality of the files on a per file basis. Notwithstanding the benefits of such fine-grained storage management, special care needs to be taken to keep the size of the split metadata to a minimum.

FIG. 3 illustrates a super-filesystem that spans two I/O domains. Each part in the super-filesystem is a filesystem itself. True containment FS=>(FS1@D1, FS2@D2, . . . ) makes the resulting super-filesystem structure—or rather the corresponding split metadata—to be a tree, with its root being the original filesystem and the “leaves” containing parts of the original filesystem data distributed over multiple I/O domains. User operations that have the scope of the entire filesystem are therefore recursively applied to this metadata tree structure all the way down to its constituent filesystems. Super-filesystem simply delegates operations on itself to its children, recursively. The split metadata may be implemented in multiple possible ways, including for instance additional control information on the level of the filesystem itself that describes how this filesystem is partitioned as shown in the bottom portion of FIG. 3.

Although generally not precluded, block level addressing removes one of the important benefits of the design, namely—mutual relative independence of the filesystem parts and their usability in isolation. Therefore, preferred embodiments of method and system in accordance with the invention implement I/O domain addressing on the levels above data blocks. Independently of its level in the hierarchy, this additional metadata, also referred here as split metadata, provides for partitioning of a filesystem across multiple I/O domains.

Embodiments of a system and method in accordance with the present invention are not limited in terms of employing only one given type, or selected level, of I/O domain addressing: block, file, directory, etc. Embodiments of a system and method in accordance with the present invention are also not limited in terms of realizing I/O domain addressing as: (a) an additional attribute assigned to filesystem objects, (b) an object in the filesystem inheritance hierarchy, (c) a layer, or layers, through which all access to the filesystem objects is performed, or (d) an associated data structure used to resolve filesystem object to its concrete instance at a certain physical location.

Embodiments of a system and method in accordance with the present invention are also not limited in terms of using one type, format or a single implementation of I/O domain addresses. The address may be a pointer within an inode structure that points to a different local inode within the same storage server. The address may point to a mount point at which one of the filesystem parts is mounted. In virtualized environments a hypervisor specific means may be utilized to interconnect objects between two virtual machines (VMs). In all cases, I/O domain address would have a certain persistent on-disk representation.

I/O domain address is an object in and of itself that can be polymorphically extended with implementations providing their own specific ways to address filesystem objects. As such, I/O domain addresses may have the following types:
(1) native local—referenced object belongs to the current filesystem and is local
(2) native—referenced object belongs to the current filesystem and is located in a different I/O domain
(3) foreign—referenced object belongs to a different filesystem within the current storage server
(4) remote—referenced object belongs to a different filesystem within remote storage server

The native types of addresses can be implemented in a filesystem-specific way, to optimally resolve filesystem objects to their real locations within the same server. The foreign address may indicate that VFS indirection is needed, to effectively engage a different filesystem to operate on the object. Finally, remote I/O domain requires communication over network with a foreign (that is, different from the current) filesystem.

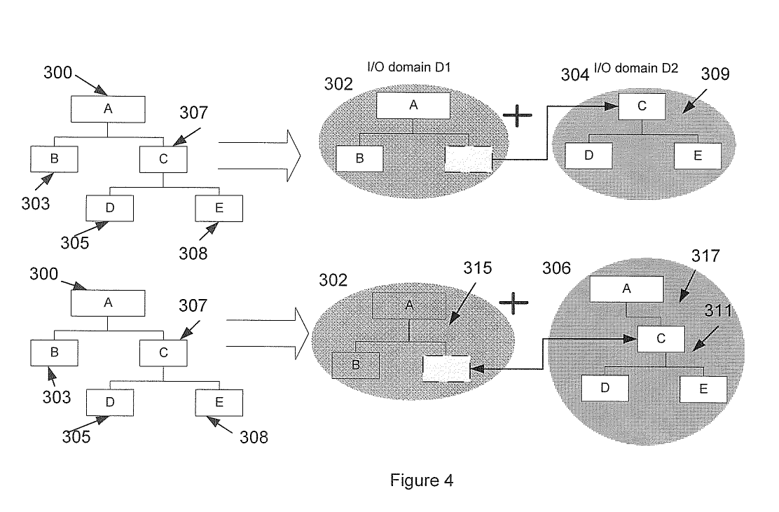

Both foreign and remote addressing provide for extending a filesystem with a filesystem of a different type. In a multi-vendor environment, control information in the form of split metadata tree can be imposed on existing filesystems from different vendors, to work as a common “glue” that combines two or more different-type filesystems into one super-filesystem—and from the user perspective, one filesystem, one folder, one container of all files. I/O domain addressability of filesystem's objects provides for deferring (delegating) I/O operations to the filesystem that contains this object, independently of the type of the former. In one embodiment, two different filesystems are linked at a directory level, so that a certain directory is declared (via its I/O domain address) to be located in the different filesystem as shown in FIG. 4. This link results in all I/O operations on this directory (NC 307 on FIG. 4) to be delegated to the corresponding filesystem that resides in I/O domain 304 or 306.

There is no one size fits all filesystem that is superior among all existing filesystems by all possible counts (including multiple counts of performance and reliability). Simultaneously, there are millions of applications deployed over existing popular filesystems. All of the above also means that majority of popular filesystems are here to stay for the foreseeable future. The critical question then is; how to take advantage of additional hardware resources and break the I/O bottleneck, while continuing to work with existing filesystems. The solution provided by a method and system and accordance with the present invention is to introduce a level of indirection (that is, an I/O domain address) between a filesystem object and its actual instance. The indirection allows for extending a filesystem in native and foreign ways, locally and remotely.

A method and system in accordance with the present invention does not restrict filesystem objects to have a single I/O domain address (and a single location). Filesystem objects, from the filesystem itself down to its data blocks, may have multiple I/O domain addresses. Multiplicity of addresses provides for a generic mechanism to manage highly-available redundant storage over multiple I/O domains, while at the same time load-balancing I/O workload based on multiplicity of hardware resources available to service identical copies of data. Conventional load balancing techniques can be used to access multiple copies of data simultaneously, over multiple physically distinct network paths (I/O multipathing). On the other hand, two different filesystems will be equally load balanced by the same load balancing software as long as the two provide for the same capability to address their objects via multiple I/O domains.

Location specific addressing incorporated into filesystem makes it a super-filesystem that can be potentially distributed over multiple I/O domains. Location specific addressability of files, directories and devices does not necessarily means that the filesystem is distributed; in fact, actual physical distribution for a given filesystem may never happen. Whether and when it happens depends on the availability of destination I/O domains, administrative policies, and other factors some of which are further discussed below. What is important is the capability to split the filesystem in parts or extend it with non-local parts, and thus take advantage of additional sets of resources.

Location specific addressing incorporated into the objects of the filesystem makes it a super-filesystem and provides for a new level of operational mobility. It is much easier and safer to move the data object by object than in one big copy-all-or-none transaction. The risk of failures increases with the amount of data to transfer, and the distance from the source to the destination. Of course, all data transfers always proceed in increments of bytes. A critical feature that a method and system in accordance with the present invention introduces is: location awareness of the filesystem objects. By transferring itself object by object and changing the object addressing accordingly (and atomically, as far as the equation “object-at-the-source equals object-at-the-destination” is concerned), the super-filesystem remains consistent at all times. If the data migration process is interrupted for any reason, administrative or disastrous, the super-filesystem remains not only internally consistent and available for clients—it also stores its own transferred state, so that, if and when data transfer is resumed, only the remaining not yet transferred objects are copied. The already transferred objects would at this point have their addresses updated to point to the destination.

In other words, I/O domain addressing eliminates the need to “re-invent the wheel” over and over again, as far as capability to resume data transfers exactly from the interruption point. Lack of this capability inevitably means loss of time and wasted resources, to redo the entire data migration operation from scratch.

Location independence of the super-filesystem FS is ultimately defined by the fact that each of its constituent filesystems (FS1, FS2, . . . ) is independently addressable. The filesystem move from I/O domain to another I/O domain (e.g., FS1 @D1=>FS1@D2) is recorded as a metadata change, transparent for the clients. In many cases this change will be as simple as changing a single pointer.

On the file client side, NFSv4 for instance includes special provisions for migrated filesystem or its part. Quoting NFSv4.1 specification (RFC 5661), “When a file system is present and becomes absent, clients can be given the opportunity to have continued access to their data, at an alternate location, as specified by the fs_locations or fs_locations_info attribute. Typically, a client will be accessing the file system in question, get an NFS4ERR_MOVED error, and then use the fs_locations or fs_locations_info attribute to determine the new location of the data.”. Similar provisions are supported by Microsoft Distributed File System (MS-DFS). A compliant NFSv4 (or DFS) server will therefore be able to notify clients that a given filesystem is not available. A compliant client will then be able to discover new location transparently for applications.

In one embodiment, constituent filesystems are periodically snapshotted at user-defined intervals, with snapshots then being incrementally copied onto different I/O domains. It is generally easier to replicate a read-only snapshot as the data it references does not change during the process of replication. In case of corruption or unavailability of any part of the super-filesystem, snapshots at the destinations can be immediately deployed via split metadata referencing. This provides for another level of data redundancy and availability in case of system failures. Of course, the split metadata itself needs to be protected by multiple redundant synchronized copies. To that end, embodiments of this invention rely on small amount of this additional control information that describes super-filesystem, with constituent filesystems that are self-sufficient full-fledged filesystems storing their own metadata.

NFSv4 and MS-DFS supported migration of the filesystems does not address the cases of partial migration. A split FS<=>(FS1@D1, FS2@D2) introduces a new scenario if either of the domains D1 or D2 is remote in respect to the I/O domain of the original filesystem. In order for the clients to continue accessing the super-filesystem data, embodiments use management daemon that runs on the client side and listens to all events associated with split, extend, and merge operations. To handle the corresponding notifications, this management daemon then performs mount and unmount operations, accordingly. The same can be done by extending existing network file protocols, such as NFS and CIFS, to relay to their clients (via additional error codes) information that describes structure of the super-filesystem and location of its constituent filesystems. As stated above, NFSv4 client will currently receive NFS4ERR_MOVED from NFSv4 server when attempting to access a migrated or an absent filesystem. Similarly, extensions of the protocol would notify its clients of a new remote location, or locations, of the filesystem “part” when the client traverses the corresponding cross-over point. The client would then take an appropriate action, transparently for the file accessing applications on its (the client's) side.

Independent of whether the mechanism used to redirect clients to those filesystem “parts” is in-band (and defined within the network file protocol itself) or out-of-band, the network file client takes appropriate actions to manage filesystem mount points dynamically and consistently, as far as the split metadata is concerned. For example, FIG. 4 shows a super-filesystem split at directory A/C 307. Assuming I/O domain D1 is local and D2 is remote, the clients would need to mount directory C at MNT_A/C, where MNT_A would be the mountpoint of the original filesystem.

The relationship FS<=>(FS1, FS2, . . . ) between the user-visible filesystem and its location-specific parts is bi-directional. Each of the constituent filesystems may reside in a single given domain D1 (example: FS1@D1) or be duplicated in multiple I/O domains (example: FS1@D1,2,3). In the latter case, filesystem FS1 has 3 alternative locations: D1, D2, and D3. Each I/O domain has its own location and resource specifiers. By definition, split metadata describes the relationship between user-visible (and from user perspective, single) filesystem FS and its I/O domain resident parts.

I/O domain addressing creates cross-over points between the filesystem parts, in terms of attributes of the filesystem objects and the scope (per-server, per-filesystem) of those attributes. There's a substantial prior art to handle such “cross-overs” on the client side. For instance, quoting RFC 5661:

“Unlike NFSv3, NFSv4.1 allows a client's LOOKUP request to cross other file systems. The client detects the file system crossing whenever the filehandle argument of LOOKUP has an fsid attribute different from that of the filehandle returned by LOOKUP.”

There are embodiments of a system and method in accordance with the present invention that completely hide the fact that (FS1@D1, FS2@D2) are two separate filesystems that are inter-connected at a certain object, by preserving the scope and uniqueness of the corresponding attributes. For instance, unique filesystem ID, referred to as ‘fsid’ in Unix type filesystems, is inherited by all constituent filesystems. Therefore, when traversing the super-filesystem namespace and crossing over from FS1 to FS2 or back, the client will not be able to detect a change in the value of the filesystem ID attribute. The same applies to other filesystem-scope attributes, such as file identifiers that, if present, are required to be unique within a given filesystem. Generally, unique per filesystem attributes retain their uniqueness across all constituent filesystems of the super-filesystem.

On the other hand, each filesystem part in a super-filesystem is usable in isolation. To that end, embodiments of a system and method in accordance with the present invention provide support for localized set of attributes—that is, the attributes that have exclusively local scope and semantics. The examples include an already mentioned filesystem and file IDs, total number of files in the filesystem, free space, and more. To illustrate it further, the free space available to the super-filesystem is a sum of free spaces of its constituents. Maintaining two sets of filesystem attributes is instrumental to achieve location independence of the filesystem parts on one hand, and the ability to use each part in isolation via standard file access protocols and native operating system APIs, on another.

In a multi-vendor environment, maintaining super-filesystem scope attributes presents additional challenges. It may be difficult or not practical attempting to reconcile, for instance, capability related attributes, such as maximum file size and support for access control lists. To extend an existing filesystem with a filesystem of a different type via foreign type I/O domain addressing, preferred embodiments of a method and system in accordance with the present invention rely on remote clients. The clients will simply mount each of the filesystems separately. In other words, the preferred embodiments can rely on conventional mechanisms mount point crossing by remote file clients.

The split metadata prescribes unique and unambiguous way to distribute files of the filesystem FS between FS1, FS2, . . . , FSn. The decision of when and how to partition an existing filesystem across different I/O domains (possibly, different data volumes on different storage servers) depends on multiple factors. For example, the most basic decision making mechanism could rely on the following statistics: (a) total CPU utilization of a given storage server, (b) percentage of the CPU consumed by I/O operations on a given filesystem, (c) total I/O bandwidth and I/O bandwidth of the I/O operations on the filesystem, measured both as raw throughput (MB/s) and IOPS. In one embodiment, these statistics are used to find out whether a given physical storage server is under stress associated with a given filesystem (or rather, I/O operations on the filesystem), and then relocate all or part of the filesystem into a different I/O domain while at the same time updating the corresponding I/O domain addressing within the filesystem.

Embodiments of a system and method in accordance with the present invention provide for a filesystem spanning multiple data volumes (FIG. 2). The filesystem metadata specifies the relationship (FS1, FS2, . . . )<=>FS, so that all operations on the filesystem FS apply to all of its parts accordingly. These are the conventional filesystem operations, including: modifying filesystem attributes, taking snapshot, cloning the filesystem, defragmenting, and all the rest operations defined on (and supported by) the filesystem. From the user perspective, there remains a single filesystem FS. From the location perspective, a filesystem FS is effectively defined as (FS1, FS2, . . . , FSn), where each FSi part (1<=i<=n) resides on its designated data volume.

There are important benefits associated with partitioning the filesystem at points that are well defined within the filesystem metadata itself, such as inodes, including file directories and data files. While achieving the goal of spreading I/O workload between different resources—most commonly, different physical computers—the approach reduces the amount of additional control information required to distribute the filesystem, which in turn immediately translates as reduced complexity of the algorithms to maintain the additional metadata that would otherwise be required to “hold” the distributed filesystem “together”.

Another important benefit is that each filesystem part is a filesystem in its own right, self-sufficient and usable in isolation as far as the data it stores is concerned. Existing solutions, including pNFS, trade this important property for the benefits of distributing lower-level blocks of data across multiple storage servers. Thus, any given file can be striped across multiple computers, which makes it possible to access those stripes concurrently, but which also means that loss of any part of metadata that describes the distribution of blocks, or any part of the file data stored on other computers, may render all the data unusable. The corresponding tradeoff can be thought of as the choice between: (1) a highly scalable system where every part depends on every other part and all the parts can be accessed concurrently, and (2) the more resilient and loosely coupled system wherein the parts are largely independent and mobile.

Related to the above, there is yet another important benefit. With tens of millions of client applications in production, it often becomes a must requirement for the new designs not to introduce the changes on the client side. And vice versa, the requirement to change the client side often becomes an insurmountable obstacle for an otherwise promising technology. A system and method in accordance with the present invention relies on the existing client APIs. On the data path, networking clients will continue using NFS and CIFS. Client applications will continue using the operating system native APIs (POSIX—for UNIX clients) to access the files.

Yet another important benefit of a system and method in accordance with the present invention is related to Solid State Drives (SSDs). SSDs, in comparison with the traditional magnetic storage, provide a number of advantages including better random access performance (SSDs eliminate seek time), silent operation (no moving parts), and better power consumption characteristics. On the other hand, SSDs are more expensive and have limited lifetimes, in terms of maximum number of program-erase (P/E) cycles. The latter are the limitations rooted deeply in the flash memory technology itself. However, there is another limitation that has nothing to do with physics—and that is the fact that SSDs are delivered to the filesystems in the package of a single data volume, a single (software or hardware based) disk array. A system and method in accordance with the present invention removes this limitation. A common scenario in that regard includes: under-utilized SSDs, with intensive random access to the filesystem that resides on a data volume that does not have SSDs. The capability to span multiple data volumes immediately produces the capability to take advantage of the SSDs, independently of whether they are present in the corresponding data volume or not.

In one embodiment, domain addressing is incorporated with each data block of the filesystem (top portion of FIG. 3). This provides for maximum flexibility of the addressing, in terms of ability to redirect I/O on a per data block basis, which also means ability to gradually migrate filesystem block by block from its current I/O domain to its destination I/O domain.

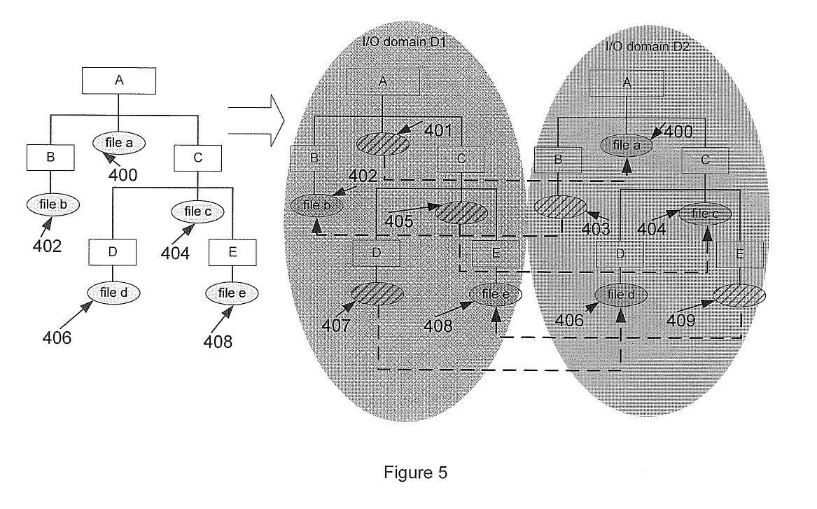

In another embodiment, domain addressing is incorporated into each inode of the filesystem. This is further illustrated on FIG. 5 where the files (400, 402, 404, 406, and 408) originally located in a single monolithic filesystem are distributed over two I/O domains as follows: files (402, 408) @D1 and files (400, 404, and 406) @D2. This effectively divides an originally monolithic filesystem at a file level, with each filesystem part appearing to the local operating system as a complete (local) filesystem. On the server side, each filesystem contains either actual files or their references into its sibling filesystem within a different I/O domain.

In general, the capability to redirect I/O on a per filesystem's inode basis translates as ultimate location independence of the filesystem itself. This capability simply removes the assumption (and the limitation) that all filesystem's inodes are local—stored on a stable storage locally within a single given I/O domain. Location-independent filesystem (or rather, super-filesystem) may have its parts occupying multiple I/O domains and therefore taking advantage of multiple additional I/O resources.

Of course, embedding I/O domain address into an inode itself constitutes only one of possible implementation choices. Bottom portion of FIG. 3 illustrates I/O domain redirection at the topmost level, with minimum amount of additional metadata to describe FS<=>(FS1@D1, FS2@D2, . . . ) and a single I/O redirect at the top. In one embodiment, the original filesystem FS is split into two filesystems (FS1@D1, FS2@D2) at a certain directory, by converting this directory within the original filesystem into a separate filesystem FS2. This is further illustrated on FIG. 4. The split metadata is then described as a simple rule: files with names containing “A/C/”, where A 300 is the root of the original filesystem, are to be placed (or found) in the I/O domain D2 (FIG. 4).

FIG. 4 at the bottom illustrates an alternative, wherein the parent of the split directory C 311 is present in both FS1@D1 and FS2@D2. The content of the directory A itself is therefore becomes distributed over two I/O domains. This has the downside of requiring two directory reads on the split directories A 315 and 317, at its corresponding I/O domains. The benefit: symmetric partitioning of the original filesystem between two selected file directories.

In another embodiment, the original filesystem FS is extended with a new filesystem FS1 in a different I/O domain (FS1@D1). From this point on all new files are placed into filesystem FS1, thus providing a growth path of the original filesystem while utilizing different set of resources for this growing filesystem. The corresponding split metadata includes a simple rule that can be recorded as follows: (new file OR file creation time>T) FS1@D1: FS, where T is the creation time of FS1.

The preferred embodiment enhances existing filesystem software with a filesystem-specific split, extend, and merge operations—to quickly and efficiently perform the corresponding operations on an existing filesystem. During these operations new filesystems may be created or destroyed, locally or remotely. The preferred embodiment performs split, extend, and merge operations as transactions—compound multi-step operations that either succeed as a whole, or not—without effecting existing clients.

For example, when splitting a given filesystem by directory, the specified file directory within the original filesystem is first converted into a separate filesystem. The operation is done in-place, with additional metadata created based on the metadata of the original filesystem. This first step of the split transaction results in two filesystems referencing each other (via split metadata) within the same original I/O domain. Next step: filesystem is migrated into a specified I/O domain. In the cases when the filesystem migration involves changing physical location of the filesystem data, the filesystem is first replicated using a replication mechanism. Finally, the split metadata is updated with the new addressing, and that concludes the transaction.

Another benefit of a system and method in accordance with the present invention is directly associated with the presence of additional addressing within the filesystem metadata (the “split metadata”). Location-specific addressing provides for generic filesystem migration mechanism. Assuming that a given filesystem object (data block, file, directory, device or entire filesystem “part”) is located in I/O domain D1, to migrate this object into a different, possibly remote, I/O domain D2, the object would be replicated using an appropriate replication mechanism, and all references to it would be atomically changed—the latter, while making sure that the object remains immutable during the process (of updating references).

Further, to duplicate this object located in domain D1 into a different I/O domain D2, the same steps would be performed with the only difference that, instead of changing all references to it to D2 it would be referenced as both @D1 and @D2, thus providing for both data redundancy and load-balancing capability, to access the object via two logical paths to the corresponding I/O domains. The decision of whether to direct I/O requests to D1 or D2 can be then based on client's geographical proximity (to D1 or D2), server utilization, or other factors used to load balance the workload.

In the embodiments with filesystems supporting point-in-time snapshots and snapshot deltas (that is, capability to provide the difference, in terms of changed files or data blocks, between two specified snapshots), the stated mechanism of migration (above) can be more exactly specified as: taking read-only snapshot of the original filesystem; copying this snapshot over to its destination I/O domain; possibly repeating the last two operations to transfer (new snapshot, previous snapshot) delta accumulated at the source while the previous copy operation was in progress; redirecting clients to use the migrated or replicated filesystem; intercepting and blocking clients I/O operations at the destination; copying the last (new snapshot, previous snapshot) delta from the source; unblocking all pending I/O requests and executing them in the order of arrival.

When a multiplicity of domain addresses and multiple copies of data is used, embodiments can rely on conventional mechanisms for synchronizing access to multiple copies of data. The synchronization may be explicit or implied, immediate or delayed. For instance, file locking primitives can be extended to either lock all copies of a given file in their corresponding I/O domains, or fail altogether. On the other hand, a lazy synchronization mechanism could involve making sure that all clients are directed to access a single most recently updated copy until the latter is propagated across all respective I/O domains.

Since a standard or a single preferred way of replicating filesystems does not exist, a system and method in accordance with the present invention provides for pluggable replication and data migration mechanisms. The split and merge operations can be extended at runtime to invoke third party replication via generic start( ), stop( ), progress( ) APIs and is done( ) callback. The flexibility to choose exact data migration/replication mechanism is important, both in terms of ability to use the best product in the market (where there are a great many choices), as well as ability to satisfy often competing requirements of time-to-replicate versus availability and utilization of system and network resources to replicate or migrate the data.

A method and system in accordance with the present invention does not preclude using conventional mechanisms to emulate split, extend and merge operations. The latter does not require changing the filesystem software and format of metadata, or incorporating I/O domain addressing into the existing filesystem metadata. In one embodiment, the merge operation is emulated using conventional methods, including: creating of a new filesystem in a given I/O domain; replicating the data and metadata from specified filesystems FS1, FS2, . . . , FSn into this new filesystem FS, and optionally deleting the source filesystems FS1, FS2, . . . , FSn. To make this operation transparent to networking clients, NFS referrals or MS-DFS redirect mechanism is used. Emulation of the split, merge and extend operations relies on the conventional mechanisms to replicate filesystems and provide a single unified namespace. The latter can allows for hiding the physical location of the filesystems from the clients, along with the fact that any client-visible file directory in the global namespace may be represented as a filesystem or a directory on a respective storage server.

A method and system in accordance with the present invention allow for incorporating I/O domain addressing at different levels in the filesystem hierarchy. The lower is the level the more flexibility it generally provides, in terms of ability to redirect I/O requests based on a changing runtime conditions. The flexibility comes at a price of size of the split metadata and associated complexity of the control path.

File-level split, for instance, generally requires two directory reads for each existing file directory. The corresponding performance overhead is minimal and can be ignored in most cases. Splitting filesystems on a file level, however, creates relatively tight coupling, with “split metadata” being effectively distributed between I/O domains and the parts of the filesystems (FS1@D1, FS2@D2, . . . ). Directory level split on the other hand is described by a split metadata that is stored with the resulting filesystem parts, making them largely independent of each other. For instance, FIG. 4 shows filesystem that is split at directory NC 307. Based on the corresponding split metadata available at both parts of the filesystem, each request for files in NC can be immediately directed to the right I/O domain, independently of where this request originated. There is no need to traverse the filesystems in order to find the right I/O domain.

A method and system in accordance with the present invention provides an immediate benefit as far as continuously and dynamically re-balancing I/O workload within a given storage server. It is a common deployment practice and an almost self-evident guideline that any given data volume contains identical disks. The corresponding disks are fast or slow, expensive or cheap, directly attached or remotely attached, virtual or physical. Data volumes formed by those disks are vastly different, in terms of their performance characteristics. Ability of the super-filesystem FS to address its data residing on different data volumes (FS1@volume1, FS2@volume2, . . . ), along with transactional implementation of the split, extend, and merge operations, provides for easy load balancing, transparent for local and remote clients.

There exist many conventional mechanisms to actively manage storage based on the frequencies of access, priority or criticality of client applications, and other criteria. The corresponding software, including Hierarchical Storage Management (HSM) software, can be ported on top of the embodiments, to actively manage the storage using generic operations described herein.

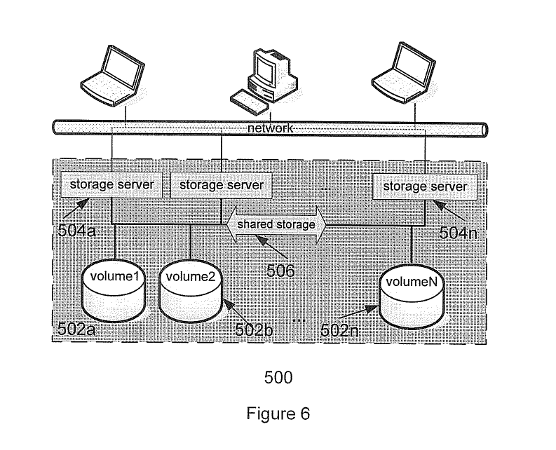

A method and system in accordance with the present invention provides for adaptive load-balancing mechanisms, to re-balance an existing filesystem on the fly, under changing conditions and without downtime. In one embodiment, two or more storage servers are connected to a shared storage 506, attached to all servers via remote interconnect (FC, FCoE, iSCSI, etc.), or locally (most commonly, via SAS). The corresponding configurations are often used to form a high-availability cluster, whereby only one storage server accesses (and provides access) to a given data volume at any given time (FIG. 6).

Each of the data volumes shown on the picture can be brought up on any of the storage servers. This and similar configurations can be used to eliminate over-the-network replications or migrations of a filesystem when re-assigning it to I/O domains within a different storage server.

The steps are: bring up some or all of the shared volumes (502a through 502n) on a selected server (one of 504a through 504n); perform split (extend, merge) operations on a filesystem so that its parts end up on different volumes; activate one of the shared volumes on a different storage server. The end result of this transaction is that all or part of the filesystem ends up being serviced through a different physical machine, transparently for the clients. The described process does require a single metadata update but does not involve copying data blocks over the network.

A method and system in accordance with the present invention provides for simple pNFS integration, via pNFS compliant MDS proxy process (daemon) that can be deployed with each participating storage server. The MDS proxy has two distinct responsibilities: splice pNFS TCP connections, and translate split metadata into pNFS Layouts.

TCP connection splicing, also known as delayed binding is a well known to enhance TCP performance, satisfy specific security or address translation requirements, or provide intermediate processing to load balance workload generated by networking clients without modifying client applications and client side protocols. On the other hand, translating split metadata to pNFS Layout is a straightforward exercise in all except “block” cases, that is, in all cases where splitting FS=>(FS1@D1, FS2@D2) is done above block level—the latter due to the fact that each file (more exactly, each copy of the file) would have all its data blocks residing in one given I/O domain, with a single given storage server.

A method and system in accordance with the present invention provides for a number of new capabilities that are not necessarily associated with I/O performance and scalability. For example, there is a new capability to compress, encrypt, or deduplicate the data on a per I/O domain basis. Each I/O domain may have its own attributes that define domain-wide data management policies, and in most cases implementation of those polices will be simply delegated to the existing filesystem software. Embodiments of this invention include a WORM-ed (Write Once, Read Many) I/O domain that protects its file data from modifications and thus performs an important security function. Each file write, append, truncate and delete operations gets filtered through the I/O domain definition, and, assuming the file is located in this I/O domain, either rejected or accepted.

Embodiments of the present invention provide for generic capability to place parts of the filesystems in memory. For high-end servers with 64 GB or more RAM it may be feasible and desirable to statically allocate certain parts of the filesystems in memory for faster processing. To that end, an I/O domain may have an attribute “in-memory”. In one embodiment, filesystem FS replicates itself into memory as follows: FS =>(FS@D,M) where D denotes the original location of the filesystem, and M is a RAM disk—a block of volatile memory used to emulate a disk. In the embodiment, each file write operation is applied twice so that the updated result is placed into both domains. File read operations, however, are optimized using in-memory domain M (based on its “in-memory” attribute). Splitting a filesystem on a file level (FS=>(FS@D, FS1@D,M)) allows to “lock” only certain designated (FS1) files into system memory. This satisfies both the requirements of data persistence and read performance, and allows reserving enough memory for other system services and application.

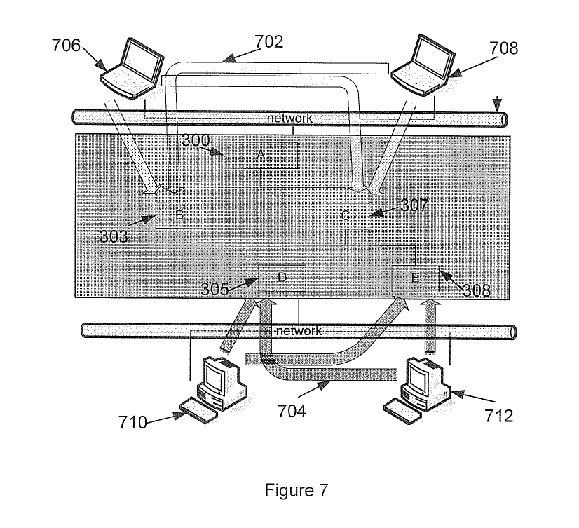

Partitioning of a filesystem across multiple I/O domains can be done both administratively and automatically. Similar to conventional operations to create, clone and snapshot filesystems, the introduced split, extend, and merge operations are provided via system utilities available for users including IT managers and system administrators. Whether the decision to carry out one of those new operations is administrative or programmed, the relevant information to substantiate the operation will typically include I/O bandwidth and its distribution across a given filesystem. FIG. 7 illustrates two clients 706 and 708 that exercise their NFS or CIFS connections to access directories 303 and 307 of the filesystem, while another pair of clients 710 and 712 performs I/O operations on 305 and 308.

Splitting the filesystem between 303 and 307 and/or 305 and 308 can be then based on rationale of parallelizing access to storage by a given application, or applications. On the other hand, splitting the filesystem at directory 307 satisfies the goal of isolating I/O workloads produced by different applications (denoted on FIG. 7 as arrows 702 and 704, respectively). A method and system and method in accordance With the invention provides for ways of re-balancing file storage dynamically, by correlating I/O flows from networking clients to parts of the filesystems and carrying out the generic split, extend and merge operations automatically, at runtime. In many cases re-balancing I/O load locally within a given server will resolve the bottleneck while at the same time saving power, space, and other resources associated with managing additional servers. In that sense, built-in mobility of the filesystem (in terms of moving between I/O domains object by object, in real time) and its capability to span multiple data volumes becomes critically important, as stated.

A system and method in accordance with the present invention allows a broader definition of which filesystem objects may be local and which remote. Such systems and methods provide a virtualized level of indirection within the filesystem itself, and rely on existing network protocols (including NFS and CIFS) to transparently access the filesystem objects located in different (virtualized) I/O domains. Location specific I/O domain addressing that can be incorporated into an existing filesystem metadata at all levels in the filesystem management hierarchy. The hierarchy can include the level of the entire filesystem, devices (including virtual devices) the filesystem uses to store its files, directory, file, and the data block level.

Embodiments of the present invention relate to an apparatus that may be specially constructed for the required purposes, or may comprise a general-purpose computer with its operating system selectively upgraded or reconfigured to perform the operations herein.

### Block Storage

From SCSI host perspective, block storage has a simple structure that can be best described as a linear sequence of logical blocks of the same size: typically, N* 512B, where integer N>=1. SCSI command protocol addresses this linear sequence via Logical Block Addresses (LBA): each logical block in the sequence has its unique LBA. Each SCSI read and SCSI write request thus carries a certain LBA and a data transfer length; the latter tells SCSI target how much data to retrieve or write starting at a given block.

Similar to any given “monolithic” filesystem, any given virtual or physical disk (Logical Unit or LU, in SCSI terms), may become a bottleneck, in terms of total provided I/O bandwidth. The leading factors as described for example in the BACKGROUND OF THE INVENTION section of the present application can be correlated to rapid ongoing virtualization of the hardware storage, moving more sophisticated logic including protocol processing into the target software stacks, the recent advances in storage interconnects including 10GE iSCSI, 10G FC, 6 Gbps SAS that put the targets under pressure to perform at the corresponding speeds, and—last but not the least—a growing number and computing power of SCSI hosts simultaneously accessing a given single LU.

Similar to a super-filesystem spanning multiple data volumes (or, more generally, multiple I/O domains), a given LU can be partitioned between I/O domains as well, to either re-balance the I/O processing within a given storage target, or move part of the processing to a different target. To this end, this invention introduces LBA map structure, to map LBA ranges to their respective I/O domains. Embodiments of this invention may implement this structure as follows:

| SCSI view | Locations | | |
|---|---|---|---|
| LUN, starting LBA | I/O domain D1, | I/O domain D2, | . . . |
| [, ending LBA] | LUN1, [starting LBA1] | LUN2, [starting | |
| | | LBA2] | |

The leftmost column of the mapping represents the user (that is, SCSI initiator) perspective, the right—actual location of the corresponding blocks in their corresponding I/O domains. The resulting table effectively performs translation of contiguous LBA ranges to their actual representations on the target side. In many cases the latter will be provided by a different SCSI target—that is, not the same target that exports the original LU (left column). I/O domain addressing will then include the actual target name (iSCSI Qualified Name (IQN)—for iSCSI, World Wide Name (WWN)—for Fibre Channel and SAS, etc.), and possibly LU persistent name (e.g., device GUID) at the location. More generally, the addressing information is sufficient and persistent—to uniquely and unambiguously identify the constituent LUs in the partitioning: LU=>(LU1@D1, LU2@D2, . . . ).

More than a single (I/O domain, LUN) destination facilitates LU replicas—partial or complete, depending on whether the [starting LBA, ending LBA] block ranges on the left (SCSI) side of the table cover the entire device or not.

Embodiments of a system and method in accordance with the present invention do not impose any limitations, as far as concrete realization of LBA mapping is concerned. For instance, LBA can be first translated into cylinder-head-sector (CHS) representation, so that the latter then used to map (for instance, each “cylinder” could be modeled as a separate LU). CHS addressing is typically associated with magnetic storage. An emulated or virtual block device does not have physical cylinders, heads, and sectors and is often implemented as a single contiguous sequence of logical blocks. In other embodiments, LBA mapping takes into account vendor-specific geometry of a hardware RAID, wherein block addressing cannot be described as a simple CHS scheme.

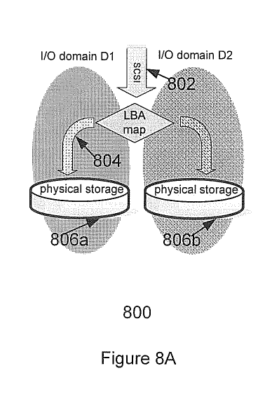

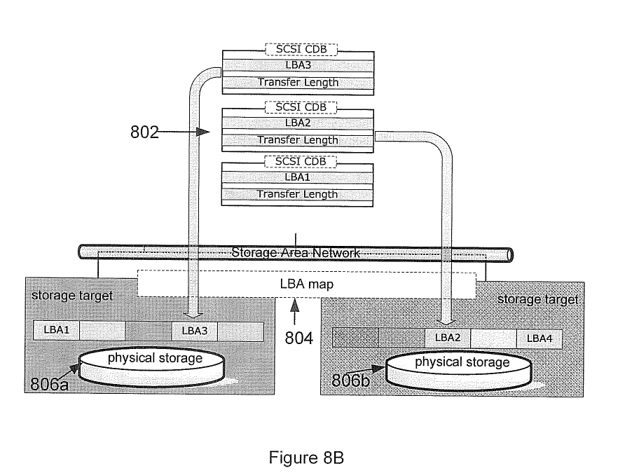

The following two diagrams (FIG. 8a and FIG. 8b) illustrate LBA mapping in action. Each SCSI Read and SCSI Write CDB carries LBA and the length of data to read or to write, respectively. Each CDB is translated using LBA map (FIGS. 8a and 8b), and then routed to the corresponding (I/O domain, LUN) destination, or destinations, for the execution. The process 804 may be performed by processing logic which is implemented in the software, firmware, hardware, or any combination of the above.

Of course, LBA map is persistent and is stored on participating devices either at a fixed location, or at a location pointed to by a reference stored at a fixed location (such as disk label, for instance). Preferred embodiments of this invention maintain a copy of LBA map on each participating LU.

Embodiments of a method and system in accordance with the present invention partition a Logical Unit in multiple ways that are further defined by specific administrative policies and goals of scalability. In the most general way this partitioning can be described as dividing a Logical Unit using a certain rule that unambiguously places each data block into its corresponding LU part. The invention introduces split, extend, and merge operations on a Logical Unit. Each LU part resulting from these operations is a Logical Unit accessible via SCSI. In combination, these LU “parts” form a super-LU that in turn effectively contains them. The latter super-LU spanning multiple I/O domains appears to SCSI hosts exactly as the original non-partitioned LU.

Similar to the super-filesystem, super-LU is defined by a certain control information (referred to as a LBA map) and its LU data parts. The relationship LU<=>(LU1@D1, LU2@D2, . . . ) between the user-visible Logical Unit and its location-specific parts is bi-directional. Each of the LU “parts” may reside in a single given domain D1 (example: LU1@D1) or be duplicated in multiple I/O domains (example: LU1@D1,2,3). In this example LU1 would have 3 alternative locations: D1, D2, and D3. Each I/O domain has its own location and resource specifiers. By definition, the LBA map describes the relationship between user-visible (and from user perspective, single) Logical Unit LU and its I/O domain resident parts.

There are no limitations on the number of LU parts to back a given SCSI device up. The parts (LU1@D1, LU2@D2, . . . ) may be collocated within a single storage target, or distributed over multiple targets on a SAN, with I/O domain addressing including target names and persistent device names (e.g., GUID) behind those targets.

In one embodiment, the original Logical Unit LU is extended with a new Logical Unit LU1 in a different I/O domain (LU1@D1). From this point on all newly allocated data blocks are placed into LU1, thus providing a growth path of the original device while utilizing different set of resources. The mechanism is certainly similar to the super-filesystem extending itself into new I/O domain via its new files.

In another embodiment, a conventional mechanism that includes RAID algorithms is used to stripe and mirror LU over multiple storage servers. A new SCSI write payload is getting striped (or mirrored) equally over all LUs as defined by the LBA map LU=>(LU1@D1, LU2@D2, . . . ). This results in a fairly good scalability of the storage backend across most applications. In particular, copy-on-write (CoW) filesystems will benefit as they continuously allocate and write new blocks for changed data while retaining older copies within snapshots.

LBA map may be used to specify more than a single location for any given LU part. For instance, LU=>(LU1@D1,D2, LU2@D1,D2) indicates that the replicas of LU1 and LU2 are present in both I/O domains D1 and D2, and can be effectively used for I/O load balancing. One important special case of this replication can be illustrated as the following mapping:

| SCSI view | Locations | | |
|---|---|---|---|
| LUN, starting | I/O domain D1, LUN1, | I/O domain D2, LUN2, | . . . |
| LBA = 0 | starting LBA1 = 0 | starting LBA2 = 0 | |

The above simply states that the entire block device is replicated across all the specified I/O domains. Those skilled in the art will appreciate that having multiple complete I/O domains' resident replicas of a given block device provides for both fault tolerance and scalability—certainly at the expense of additional storage.

In one embodiment, each SCSI Write CDB is written into all LU destinations. For instance, (FIGS. 8a and 8b) shows two devices in the LBA map. Assuming, LU=>(LU1@D1,D2, LU2@D1,D2), each write would be replicated into both LU1 806a and LU2 806b. This keeps the corresponding LU parts constantly in sync, and provides for read load balancing.

There are other similarities between a super-LU and a super-filesystem. Specifically for the software emulated Logical Units, the invention provides for an important benefit in regards to Solid State Drives. Common scenarios in that regard include: under-utilized SSDs, and intensive random access to a given LU that resides on a data volume or disk array that does not have SSDs. With the capability to span multiple data volumes immediately comes the capability to take advantage of the SSDs, independently of whether they are present in the corresponding data volume or not.

Further, the super-LU achieves a new level of operational mobility as it is much easier and safer to move the block device (block range) by (block range), than in a single all-or-nothing copy operation. The risk of failures increases with the amount of data to transfer, and the distance from the source to the destination. If the data migration process is interrupted for any reason, administrative or disastrous, the super-LU remains not only internally consistent and available for clients—it also stores its own transferred state via updated LBA map, so that, if and when data transfer is resumed, only the remaining not yet transferred blocks are copied.

Migrating constituent LUs from a given storage target to another storage target over shared storage applies to block storage as well, as illustrated on FIG. 6.

The previously described sequence of steps to migrate parts of the filesystem applies to the super-LU as well. The steps are: bring up some or all of the shared volumes 502a through 502n (FIG. 6) on a selected server; perform split (extend, merge) operations on a LU so that its parts end up on different volumes; activate one of the shared volumes on a different storage server. This will require a single metadata update (of the type of LU1@D1=>LU1@D2), but it does not involve copying data blocks over the network.

Similar to the super-filesystem, super-LU embodiments are also not limited in terms of using one type, format or a single implementation of I/O domain addresses that may have the following types: native local, native, foreign, remote—the latter to reference LU within a remote storage target. Being a level of indirection between a SCSI visible data block and its actual location, I/O domain addressing provides for extending Logical Units in a native or foreign ways, locally or remotely.

The preferred embodiment enhances existing storage target software with a split, extend, and merge operations—to quickly and efficiently perform the corresponding operations on an existing Logical Units. During these operations new LUs may be created or destroyed, locally or remotely. The preferred embodiment performs split, extend, and merge operations as transactions—compound multi-step operations that either succeed as a whole, or not—without effecting existing initiators.

In the embodiments where the storage software supports point-in-time snapshots and snapshot deltas (that is, the capability to provide difference, in terms of changed blocks, between two specified snapshots), LU migration can be done in steps. These steps include but are not limited to: taking read-only snapshot of the original LU; copying this snapshot over to its destination I/O domain; possibly repeating the last two operations to transfer (new snapshot, previous snapshot) delta accumulated at the source while the previous copy operation was in progress; redirecting SCSI initiators to use the migrated or replicated LU; intercepting and blocking I/O operations at the destination; copying the last (new snapshot, previous snapshot) delta from the source; unblocking all pending I/O requests and executing them in the order of arrival.

Since a single preferred way of replicating Logical Units does not exists, a method in accordance with the present invention provides for pluggable replication and data migration mechanisms. The split and merge operations can be extended at runtime to invoke third party replication via generic start( ), stop( ), progress( ) APIs and is done( ) callback. The flexibility to choose exact data migration/replication mechanism is important, both in terms of ability to use the best product in the market (where there are a great many choices), as well as ability to satisfy often competing requirements of time-to-replicate versus availability and utilization of system and network resources to replicate or migrate the data.

The LBA map can be delivered to SCSI Initiators via Extended Vital Product Data (EVPD), which is optionally returned by SCSI target in response to SCSI Inquiry. Initiators that are aware of how the device is distributed across I/O domains can then execute SCSI requests directly on the corresponding LU “parts”. In one embodiment, I/O domains D1, D2, . . . each represents a separate hardware based storage target. Each of those targets obtains a synchronized copy of the LBA map that defines the partitioning LU=>(LU1@D1, LU1@D2, . . . ). SCSI Initiator receives the map via SCSI Inquiry executed on any of the targets, and then talks directly to those targets based on (LBA, length)=>(I/O domain, LU) resolution as defined by the map.

A method and system in accordance with the invention provides for a number of new capabilities that are not necessarily associated with I/O performance and scalability. For example, there is a new capability to compress, encrypt, or deduplicate the data on a per I/O domain basis. Each I/O domain may have its own attributes that define domain-wide data management policies. Embodiments of a method and system in accordance with the present invention include a WORM-ed (Write Once, Read Many) I/O domain that protects its block data from modifications: once new logical blocks are allocated on the device and initialized (via for instance, WRITE_SAME(10) command, each block is written only once and cannot be changed.

Embodiments of the present invention provide for generic capability to place and maintain a copy of a certain part of the block storage in RAM. Similar to super-filesystem, an I/O domain used to map a given super-LU may have an attribute “in-memory”. In one embodiment, Logical Unit LU replicates itself into memory as follows: LU=>(LU@D,M) where D is the original location of the device, and M is a RAM disk. Each block write operation is applied twice, so that the updated result is placed into both domains. SCSI read operations, however, are optimized using in-memory domain M. Still another embodiment places only portion of the device into memory, as specified in the LBA map LU=>(LU1@D1, LU2@D2,M). The LU2 here has replica in both persistent (D2) and volatile (M) domains. This satisfies both the requirements of data persistence and read performance, and allows reserving enough memory for other system services and application.

A method and system in accordance with the present invention provides for applications such as filesystems, databases and search engines) to utilize faster, more expensive, and possibly smaller in size disks for certain types of data (e.g. database index), while at the same time leveraging existing, well-known and proven replications schemes (such as RAID-1, RAID-5, RAID-6, RAID-10, etc.). In addition, embodiments provide for integrated backup and disaster recovery, by integrating different types of disks, some of which may be remotely attached, in a single (heterogeneous) data volume. To achieve these objectives, a system and method in accordance with the present invention is can rely fully relying on existing art, as far as caching, physical distribution of data blocks in accordance with the chosen replication schemes, avoidance of a single point of failure, and other well-known and proven replications schemes.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for resolving a single server bottleneck, the method comprising:
performing one or more of the following operations: a) splitting a filesystem into two or more filesystem parts; b) extending a filesystem residing on a given storage server with its new filesystem part in a certain specified I/O domain; c) migrating or replicating one or more of those parts into separate I/O domains; d) merging some or all of the filesystem parts to create a single combined filesystem, and
then redirecting filesystem clients to use the resulting filesystem spanning multiple I/O domains.

2. The method of claim 1, wherein an I/O domain is defined as a logical entity that owns physical, or parts of the physical, resources of a given physical storage server (CPUs, CPU cores, disks, RAM, RAID controllers, HBAs, data buses, network interface cards), logical resources of a given physical storage server (number of threads, number of processes, the thread or process execution priority), or any other operating system resources that define or control access to physical resources utilized by I/O operations on the filesystem.

3. The method of claim 1, wherein a filesystem residing in a certain I/O domain is extended with a new filesystem residing in a different I/O domain and available for clients via standard file access protocols and native operating system APIs.

4. The method of claim 1, wherein a filesystem FS residing in a certain I/O domain is split into two or more filesystems (FS1, FS2, . . . FSn) residing in their respective I/O domains and each available for clients via standard file access protocols and native operating system APIs.

5. The method of claim 1, wherein two or more filesystems FS1, FS2, . . . FSn resulting from a split or extend operations on the original filesystem FS are merged together to create a new filesystem FS within a specified I/O domain that may differ from some or all of the I/O domains of its constituent filesystems.

6. The method of claim 1, wherein the filesystem is enhanced with a filesystem-specific split, extend, and merge operations, to quickly and efficiently divide the filesystem into parts or combine those parts together, while at all times maintaining logical relationship FS<=>(FS1, FS2, . . . , FSn) between the original filesystem and its parts via filesystem-specific metadata.

7. The method of claim 6, wherein I/O domain addressing is incorporated into the certain types of filesystem inodes, so that an inode can be modified to address an object located in a different I/O domain.

8. The method of claim 1, wherein the split, extend, and merge operations are emulated using existing conventional mechanisms already supported by the filesystem software and its operating system.

9. The method of claim 1, wherein the split, merge, and extend operations are transparent for local and remote clients, as far as access to the filesystem data is concerned.

10. The method of claim 8, wherein NFS and CIFS clients accessing the original filesystems via their respective NFS (CIFS) shares are redirected to instead access filesystems resulting from the split, extend and merge operations, by employing existing standard NFS referrals or MS-DFS redirects mechanisms, respectively.

11. The method of claim 1, wherein the split, extend and merge operations are executed on existing filesystems, at runtime and without interrupting user access while re-balancing and distributing I/O bandwidth across multiple I/O domains.

12. The method of claim 1, wherein a filesystem records its migrated or replicated state during migration (replication) and provides for resuming the operation from the recorded state that is defined by the filesystem's own I/O domain addressable objects.

13. A method for resolving a single storage target bottleneck, the method comprising:
performing one or more of the following operations: a) splitting a virtual block device accessed via a given storage target into two or more parts; b) extending a block device with a new block device part residing in a certain specified I/O domain; c) migrating or replicating one or more of those parts into separate I/O domains; d) merging some or all of those parts to create a single combined virtual block device, and
then redirecting hosts on the Storage Area Network (SAN) to access and utilize the resulting block devices in their respective I/O domains.

14. The method of claim 13, wherein an I/O domain is defined as a logical entity that owns physical, or parts of the physical, resources of a given physical storage target (CPUs, CPU cores, disks, RAM, RAID controllers, HBAs, data buses, network interface cards), logical resources of a given physical storage target (number of threads, number of processes, the thread or process execution priority), or any other operating system resources that define or control access to physical resources utilized by I/O operations on the Logical Unit.

15. The method of claim 13, wherein a Logical Unit (LU) accessed via a given storage server is split (or striped) into two or more LUs, each located in its respective I/O domain, or extended with additional LU located in an I/O domain separate from the I/O domain of the original LU.

16. The method of claim 13, wherein an LU is split into a pair (LU1, LU2) of Logical Units using a programmable rule that partitions the LU LBA ranges into two non-overlapping sets of LBAs that in combination produce the entire set of original addresses.

17. The method of claim 13, wherein a thin provisioned LU residing in a certain I/O domain is extended with a new Logical Unit LU1 in a different I/O domain, so that each new block is allocated within and for LU1.

18. The method of claim 13, wherein two or more Logical Units LU1, LU2, . . . LUn resulting from a split or extend operations on a given LU are merged together to recreate the original LU within its original I/O domain or within a different I/O domain.

19. The method of claim 13, wherein two or more Logical Units resulting from splitting (striping) or extending of the original Logical Unit are made available to hosts on the SAN via iSCSI, Fibre Channel Protocol, FCoE, Serial Attached SCSI (SAS), SRP (SCSI RDMA Protocol), or any other protocol that serves as a transport for SCSI commands and responses and provides access to SCSI devices.

20. The method of claim 13, wherein the storage subsystem software of a storage server is enhanced with a split and extend operations, to quickly and efficiently divide the original LU into two or more new Logical Unit parts (LU1, LU2, . . . ) within their respective I/O domains, while at the same time maintaining logical relationship LU<=>(LU1, LU2, . . . ) between the original Logical Unit and its parts.

21. The method of claim 20, wherein as part of the split, extend or merge operation a given Logical Unit is migrated or replicated into a different I/O domain, without interrupting clients I/O operations during the process of migration (replication).

22. The method of claim 13, wherein the split, extend and merge operations are emulated using existing mechanisms provided by the storage subsystem software that virtualizes underlying hardware storage.

23. The method of claim 13, wherein LU is migrated or replicated to a different I/O domain that owns a certain subset of logical or physical resources of a given local or remote storage target.

24. The method of claim 13, wherein hosts on the SAN accessing the original block device LU via any compliant SCSI interconnect are redirected to instead access (LU1, LU2, . . . , LUn) resulting from the split operation on the original LU, by translating a given requested block number into a block number on one of the Logical Unit parts (LU1, LU2, . . . , LUn).

25. The method of claim 24, wherein a storage subsystem software of a SCSI initiator is enhanced with the ability to inquire and process metadata information, including block numbers and ranges associating with (or, resulting from) the split, extend, and merge operations performed on the original LU, including the ability to translate or map the block number on the original LU into a block number on the corresponding LU resulting from split, extend, or merge operations.

26. The method of claim 13, wherein the split, extend and merge operations are executed on existing Logical Units, at runtime and without interrupting user access while re-balancing and distributing I/O bandwidth across the corresponding I/O domains.

27. A computer readable storage medium containing program instructions executable on a computer for resolving a single server bottleneck, wherein the computer performs the following functions:
performing one or more of the following operations: a) splitting a filesystem into two or more filesystem parts; b) extending a filesystem residing on a given storage server with its new filesystem part in a certain specified I/O domain; c) migrating or replicating one or more of those parts into separate I/O domains; d) merging some or all of the filesystem parts to create a single combined filesystem, and
then redirecting filesystem clients to use the resulting filesystem spanning multiple I/O domains.

28. A computer readable storage medium containing program instructions executable on a computer for resolving a single server bottleneck, wherein the computer performs the following functions:
performing one or more of the following operations: a) splitting a virtual block device accessed via a given storage target into two or more parts; b) extending a block device with a new block device part residing in a certain specified I/O domain; c) migrating or replicating one or more of those parts into separate I/O domains; d) merging some or all of those parts to create a single combined virtual block device; and
then redirecting hosts on the Storage Area Network (SAN) to access and utilize the resulting block devices in their respective I/O domains.
